(19) United States
(12) Patent Application Publication
(10) Pub. No.: US 2009/0177751 A1
(43) Pub. Date: Jul. 9, 2009

(54) Mail transmission method

(75) Inventors: Yoshiko Ito, Urayasu (JP); Tsuyoshi Kawaguchi, Kawasaki (JP); Rikiya Uefune, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 12/229,962

(22) Filed: Aug. 27, 2008

(30) Foreign Application Priority Data
Jan. 8, 2008 (JP) 2008-000872

(51) Int. Cl. G06F 15/16

(52) U.S. Cl. 709/206

(57) ABSTRACT

A mail server unit receives an electronic mail sent by a mail sender, the mail being received via a mailer of a terminal of the mail sender, sets a browsing privilege for an attachment of the mail and encrypts the attachment, controls the browsing privilege for the attachment, executes error processing when control items are set to the attachment, and executes processing to decrypt an encrypted attachment.

### INCORPORATION BY REFERENCE

The present application claims priority from Japanese application JP2008-000872 filed on Jan. 8, 2008, the content of which is hereby incorporated by reference into this application.

### BACKGROUND OF THE INVENTION

The present invention relates to an electronic mail or e-mail system, and in particular, to access control for an attachment or attachment file of an e-mail.

Today, it has been required to cope with problems occurring in computer systems, for example, information leakage. Particularly, for e-mail or mail, there exist risks of leakage, falsification, and erroneous transmission. The e-mail is communicated with a file attached thereto, i.e., an attachment in many cases. In many methods of controlling access to the attachment, the attachment is first saved in an associated file and then access control is implemented when the attachment is accessed. In another access control method, to control access to an attachment desired by a user, a server keeps attachment access control information for the access such as a user identification (ID), a password, and a privilege of the user to refer to an attachment.

In the latter method, to browse the attachment, the user issues a query for the access control information via a network. The user is allowed to open the attachment only if the user has an associated access authority. That is, information control can be implemented even for an attachment transmitted onto the network through information leakage. That is, by registering access control information of the attachment, a browse inhibited state can be set by use of the access control information. It is hence possible to control information for an attachment which has already been distributed.

In association with these methods, JP-A-2006-344000 describes a method of encrypting an attachment by separately using an encrypted file, which saves labor.

JP-A-2006-344000 describes a method in which attachments are registered to an attachment access control server to thereby control the attachments in a unified way. That is, at transmission of an e-mail, an attachment to be encrypted is designated. An encryption key for the designated attachment is obtained from the file access control server to encrypt the attachment and then the encrypted attachment is registered to the file access control server. In a case wherein authentication information sent from the side of a receiver unit is authenticated by the control server, an access authority to access the attachment stored in the control server is assigned to the receiver unit. Moreover, in association with the operation, a client terminal as the transmission source can change the access authority to access the attachment stored in the control server.

### SUMMARY OF THE INVENTION

In the access control method for an attachment of an e-mail, the attachment is automatically saved in a file server at transmission of the mail to achieve attachment access control. However, after the mail receiver has obtained the attachment, it is not possible to conduct the access control for the attachment.

In the method as in the prior art, an attachment and its access control information are saved in a server such that when the attachment is browsed, the access control information thereof is referred to via a network to determine allowance or rejection of the browse of the attachment. This method is capable of controlling allowance or rejection of the browse of an attachment as an object of the access control at any time. However, at the present stage of art, the method is implemented as independent software in which the access control information of the attachment is manually registered from a computer screen. To transmit and to receive an attachment in this method, it is required to manually register access control information of the attachment. Such operation is troublesome and is not convenient for the user.

For example, when an attachment is attached to an e-mail, it is required that the file or attachment is processed by dedicated software capable which can control access control information of the attachment and which can control the access control information before the file is attached to the e-mail to register by the software the access control information (such as a browsing allowed person and a browsing allowed period) as access control information to the server. Also, there exists a problem wherein when the e-mail including a text is, for example, erroneously transmitted, the text is leaked.

Additionally, in a situation wherein an e-mail with a file attached thereto is transmitted, if the receiver has obtained the attachment, the access control cannot be conducted for the attachment thereafter.

It is therefore an object of the present invention, which is devised to solve at least one of the problems, to provide a file or attachment access control method on the basis of mail transmission software, a mail transmission server, and file or attachment access control information. In the method, for an attachment of e-mail or mail, access control information of the attachment is saved in a server such that the access control is possible after the receiver has obtained the attachment.

According to the present invention, for a piece of mail or an e-mail for which a transmission request is issued, a registration screen is sent to a receiver unit, the screen being configured to receive an input of information indicating transmission of the mail and an input of information authenticating a receiver (and/or information desiring reception). When the receiver is authenticated according to the input items on the receiver unit (and/or when the information desiring reception is received), the mail is sent to the receiver unit. In the operation, for mail satisfying a predetermined condition, for example, designation of encryption for the attachment, the processing above may be executed. It is also included that until the authentication is achieved, the transmitted mail is kept stored in a predetermined wait area. Also, it is included that if neither the information of authentication nor the information desiring reception is received or the authentication is not achieved for at least a fixed period of time, the mail is deleted. The present invention also includes deleting the mail from the transmitter unit and changing the destination of the mail. Using these operation modes, it is possible to control mail reception according to the present invention.

More specifically, there is provided according to the present invention a mail transmission method in which a transmitter unit for transmitting electronic mail or mail transmits the mail to a receiver unit as a destination thereof. The method includes the steps of:

transmitting an electronic mail from the transmitter unit to a server unit;

storing the mail by the server unit;

receiving by the server unit, from the transmitter unit, information of a condition to deliver the mail stored by the server unit to the receiver unit;

transmitting by the server unit a registration screen to the receiver unit as a destination of the mail, the screen receiving input of information that the mail has been transmitted, information to authenticate a receiver of the mail, and/or information to desire reception of the mail;

receiving by the server unit, from the receiver unit, contents of the input from a user to the registration screen; and

comparing by the server unit, the contents thus received with the information of the condition and transmitting the mail to the receiver unit if the contents satisfy the information of the condition.

The embodying mode also includes a configuration in which a registration screen is transmitted in response to a request from a receiver side. In this regard, there is also included a configuration in which when the receiver unit closes the mail, the mail is deleted from the receiver unit. That is, the present invention also includes an operation to execute comparing processing each time it is desired to open an e-mail.

Additionally, the present invention also includes operation modes as follows.

Invalidating processing including encryption is conducted for an attachment (for example, if a predetermined condition is satisfied, the contents of the attachment can be displayed). A correspondence is established between a mail ID identifying an e-mail and an attachment ID identifying an attachment of the mail. A correspondence is established between an attachment ID and a validating condition to validate the attachment (to release the invalidated state of the attachment). If the validating condition is satisfied, a validating key is issued to be used in the validating processing. In this connection, a mail ID is sent from the receiver side to determine an attachment ID corresponding to the mail ID and to resultantly determine a validating key corresponding to the attachment ID. As a result, the validating key can be obtained without notifying the attachment ID. Particularly, in a situation wherein a plurality of attachments exist for one e-mail (in particular, mutually different validating conditions are set to the attachments), it is possible to dispense with the troublesome job. In the operation, the invalidating processing and subsequent processing may be executed if a predetermined condition is satisfied, for example, if there exists an attachment.

The validating key may be controlled by establishing a correspondence between the validating key and an attachment ID corresponding thereto. In this case, it is configured such that the validating key is beforehand reserved such that when the receiver unit designates an attachment, the validating key is actually used. As above, a plurality of attachments may be respectively validated. When transferring an attachment, the attachment ID thereof may be continuously used (a mail ID is associated in information with the original mail ID). To transfer also the mail ID, there may be employed a configuration in which the original mail ID is continuously used. In this regard, “to be continuously used” may be “to use the same ID” or “to use a value obtained by converting the original ID according to a predetermined relationship (for example, by adding one thereto or by increasing the number of digits thereof). According to the configuration, it is possible to reduce the amount of information items of the security information database. For a plurality of attachments, there may be utilized a group ID to comprehensively identify the group of the attachments.

The present information also includes combinations of the respective modes described above.

According to the present information, there can be representatively obtained two advantages as below.
(1) At transmission of mail, file access control information can be obtained, set, and saved in a sequential way.
(2) For an attachment which is leaked by mistake at transmission thereof due to, for example, erroneous transmission, it is possible to automatically provide a chance to control browsing information of the attachment at any time.

Other objects, features and advantages of the invention will become apparent from the following description of the embodiments of the invention taken in conjunction with the accompanying drawings.

### BRIEF DESCRIPTION OF THE DRAWINGS

FIG. 1A is a flowchart showing “(B) file encryption function” in an embodiment of a processing procedure according to the present invention.

FIG. 1B is a flowchart showing “(C) user information registration query function” and “(D) error processing function” in an embodiment of a processing procedure according to the present invention.

FIG. 1C is a flowchart showing “(E) user information registration function” in an embodiment of a processing procedure according to the present invention.

FIG. 1D is a flowchart showing “(F) attachment decryption function” in an embodiment of a processing procedure according to the present invention.

FIG. 2 is a block diagram showing a system configuration in the embodiment of FIG. 1.

FIG. 3 is a diagram showing a layout of a security information confirming screen displayed on a screen 11 in step 1011 of FIG. 1.

FIG. 4 is a diagram showing a list of security information database items of a database 22 in FIG. 2.

FIG. 5 is a diagram showing a list of user information registration database items of a database server 23 in FIG. 2.

FIG. 6 is a diagram showing a text example of user information registration request mail to be created in step 2002 of FIG. 1 by an application server 20.

FIG. 7 is a diagram showing a text example of unregistered user notification mail to be created in step 2004 of FIG. 1 by the application server 20.

FIG. 8 is a diagram showing a text example of validation period expiration notification mail to be created in step 3011 of FIG. 1 by the application server 20.

FIG. 9 is a diagram showing a user information registration request screen to be created in step 4004 of FIG. 1 by the application server 20.

FIG. 10 is a diagram showing an authentication screen to be created in step 4028 of FIG. 1 by the application server 20 for the user information registration request screen.

FIG. 11 is a diagram showing an authentication result notification mail text to be created in step 4031 of FIG. 1 by the application server 20.

FIG. 12 is a flowchart showing an outline of FIGS. 1A to 1C and is a (simplified) embodiment of processing procedure according to the present invention.

FIG. 13 is a diagram showing a correspondence table between mail ID and attachment ID.

### DESCRIPTION OF THE EMBODIMENTS

Referring now to the drawings, description will be given of an embodiment of the present invention.

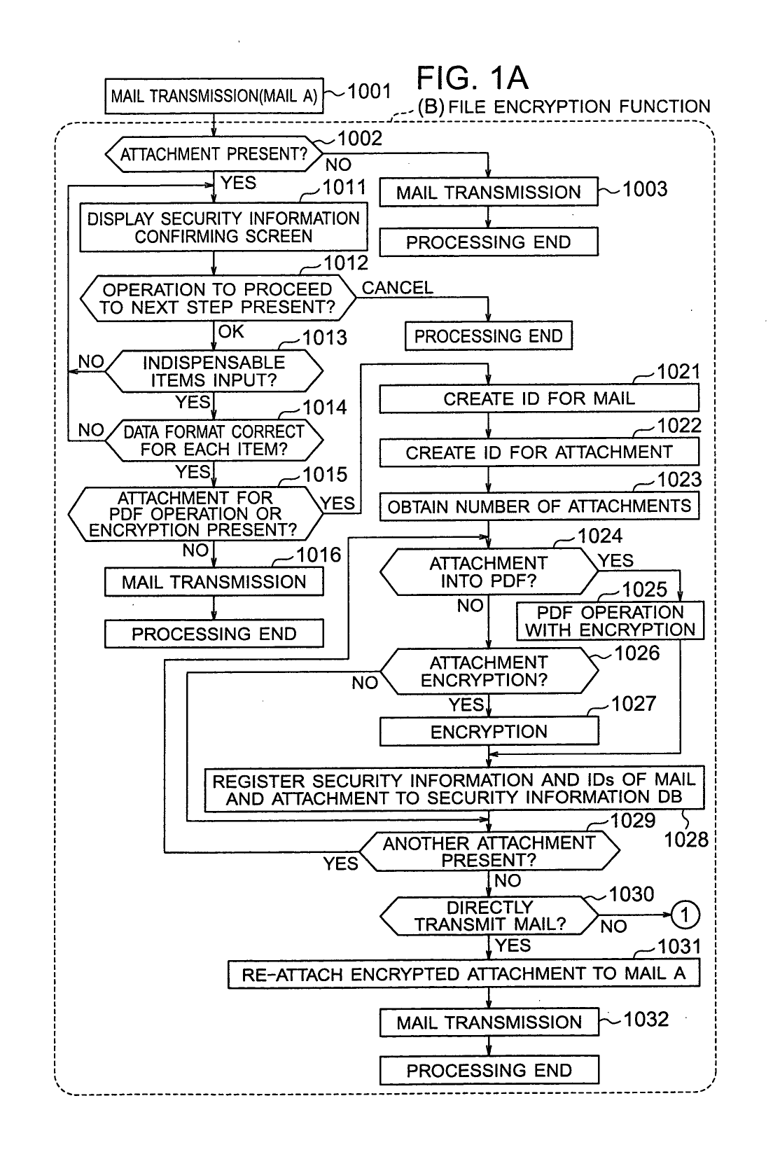

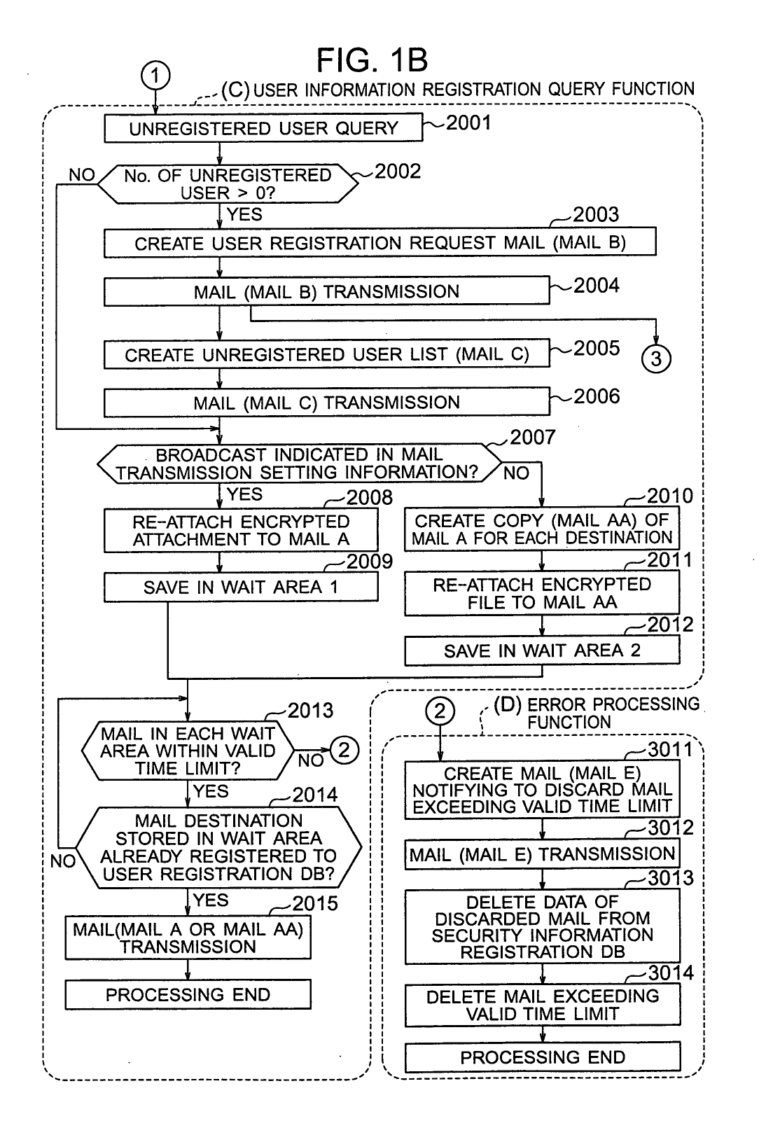

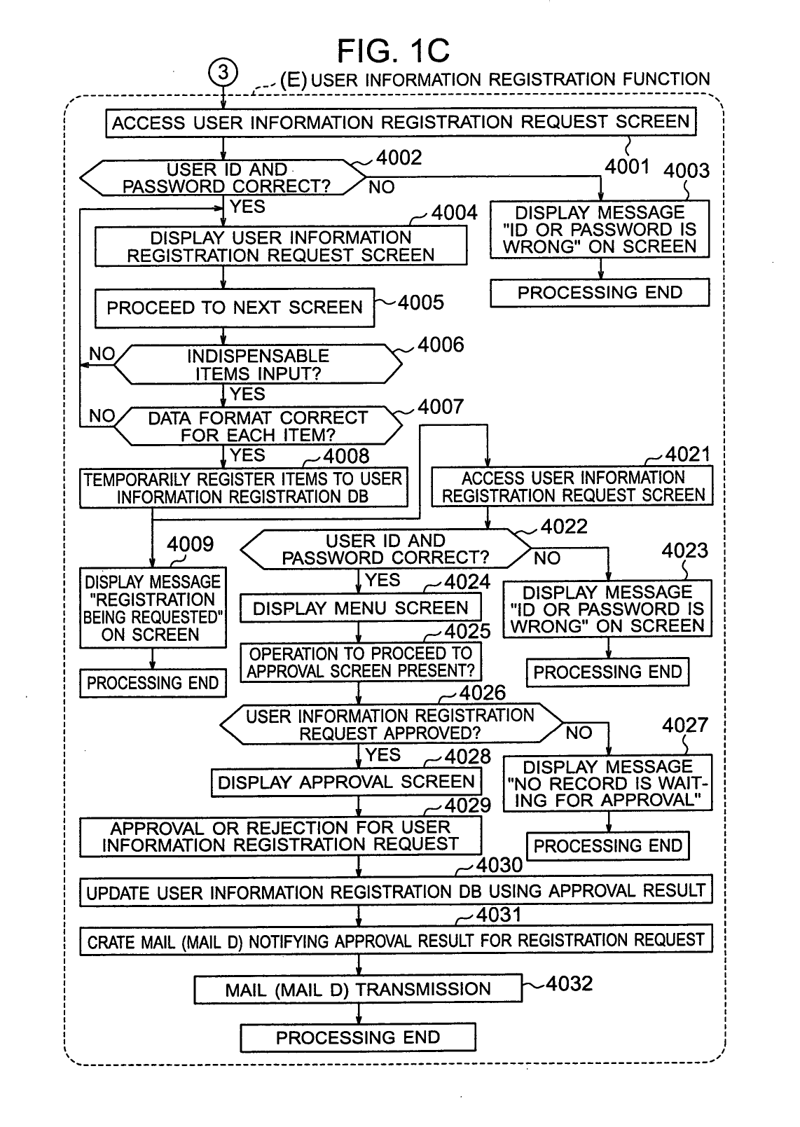

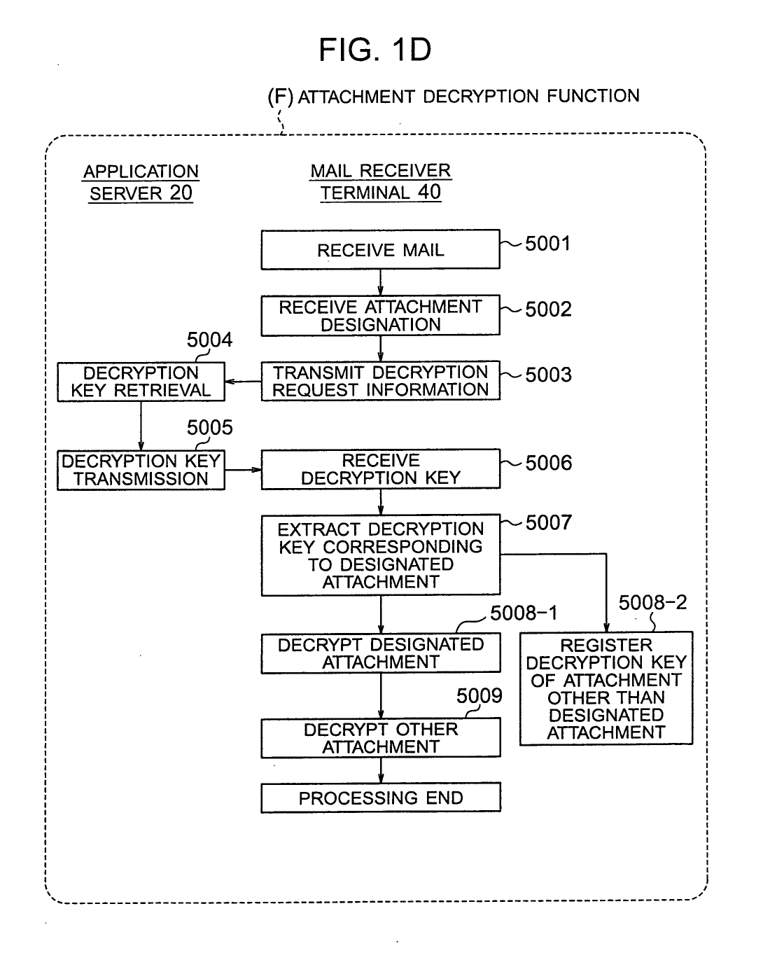

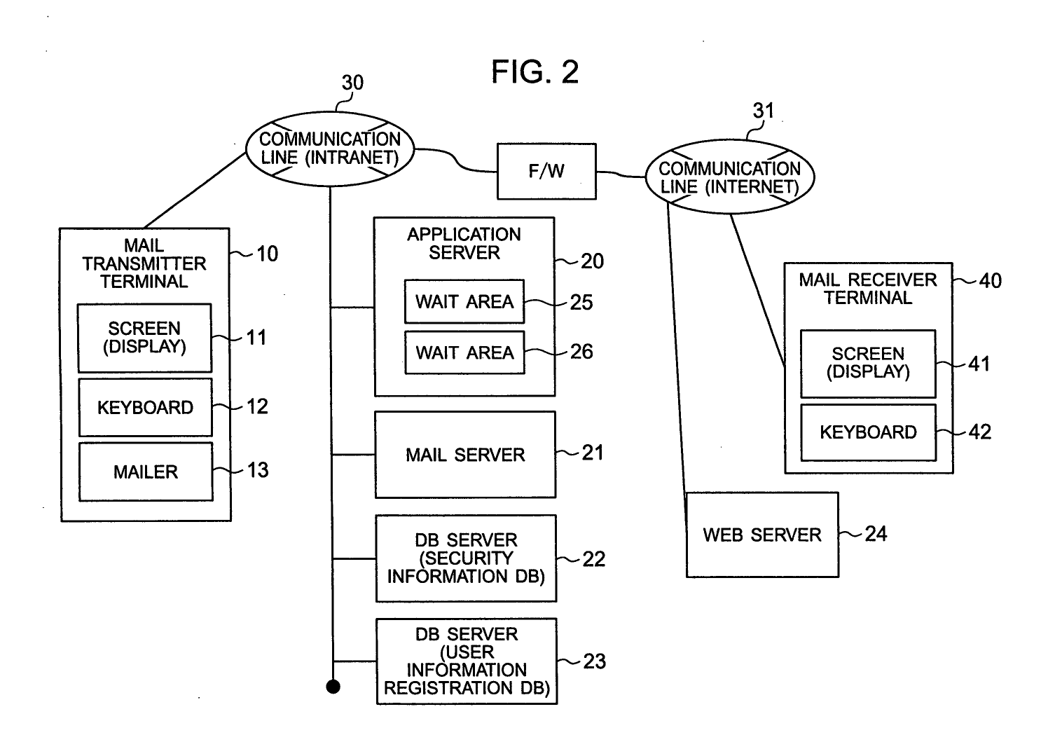

FIGS. 1A to 1C are flowcharts showing an example of a processing procedure in an embodiment of the present invention. Each step is assigned with a step number. FIG. 2 shows a system configuration implementing the embodiment of FIG. 1.

The embodiment primarily includes the following six functions (A) to (F) which operate in association with each other.
(A) Mail creation/transmission function
(B) Attachment encryption function
(C) User information registration query function
(D) Error processing function
(E) User information registering function
(F) Attachment decryption function

These functions correspond respective to functions (A) to (F) shown in FIGS. 1A to 1D. Function (A) is incorporated in associated locations of functions (B) to (E) of FIGS. 1A to 1C.

Referring to FIG. 2, description will be given of constituent components of the embodiment. The respective constituent components are connected via a network to each other and respectively include computers. That is, the component includes a processing section such as a Central Processing Unit (CPU) and a storage to store therein programs and the like. According to the programs, the processing section executes processing, which will be described later.

The embodiment includes a mail transmitter terminal 10 including a personal computer, an application server 20 including wait areas 25 and 26 to temporarily keeps therein mail sent from the mail transmitter terminal 10, a mail server 21, a security information database 22 to store mail parameters and the like which are information items associated with mail in the embodiment, a user information registration database 23 to register therein information on the receiver side, the information being used to transmit mail to the receiver side; a web server 24, and a mail receiver terminal 40 including a personal computer. Although the servers and the databases are implemented using separated hardware modules in the embodiment, it is not necessarily required that these constituent components are separated from each other in this way. The mail transmitter terminal 10, the application server 20, the mail server 21, the security information database 22, and the user information registration database 23 are connected via a communication line, i.e., an intranet 30 to each other.

The mail receiver terminal 40 and the web server 24 are connected via a communication line, i.e., the internet 31 to each other. Between the intranet 30 and the internet 31, there is arranged a firewall (F/W). It is also possible that the mail receiver terminal 40 is connected via a firewall connected to the internet 31 and the intranet 30.

Although FIG. 2 shows one mail transmitter terminal 10 and one mail receiver terminal 40, it is also possible that the system includes a plurality of mail transmitter terminals and a plurality of application servers 40 which are respectively connected to the associated networks. The terminals 10 and 40 respectively include personal computers which respectively include display screens or displays 11 and 41, keyboards 12 and 42, and mouse modules. Each of the terminals 10 and 40 includes a mailer, i.e., software to communicate mail. Like the other programs, the mailer is also executed by a processing section, not shown. That is, such terminal may be adopted as either one of the terminals 10 and 40. The mail receiver terminal 40 includes, in addition to the mailer, an application program to handle or to open an attachment. According to the application program and the mailer, the system executes processing shown in FIG. 1D.

Next, referring to the processing procedures of FIGS. 1A to 1C and the system configuration of FIG. 2, description will be given in detail of processing steps of FIGS. 1A to 1C.

Referring first to FIG. 1A, description will be given processing of “(B) file encryption function”.

The mail receiver terminal 10 activates the mail software (mailer 13) according to an indication (input) from the mail sender to receive a mail text and a mail destination. If the sender desires to attach a file, i.e., an attachment to the mail, the mailer receives an associated indication (input) from the mail sender. After the sender has created the mail, the mailer 13 executes mail transmission processing in response to a mail transmission operation of the sender. The mail transmission processing conducted by a mail creator is activated in response to an operation conducted by the mail sender by using the screen 11 and the keyboard 12 (including the cursors) of the terminal 10, for example, when the sender depresses a mail transmission button. As a result, the mailer 13 transmits a processing request via the communication line 30 to the application server 20 (step 1001). The mailer 13 used in this case includes functions for cooperative operations with the system having the functions (A) to (F) of the embodiment.

The application server 20 receives the mail (to be referred to as mail A hereinbelow) transmitted from the terminal 10. The server 20 determines presence or absence of an attachment for mail A (step 1002). If the mailer 13 is, for example, based on specifications of MIME, the presence or absence of an attachment can be determined by “multi-part” on the system side.

If absence of such attachment is determined, the application server 20 transmits mail A via the communication line 30 to the mail server 21. The server 21 then executes transmission processing for mail A (step 1003) and then terminates the processing. Resultantly, mail A is delivered via the lines 30 and 31 to be displayed on the receiver terminal 40.

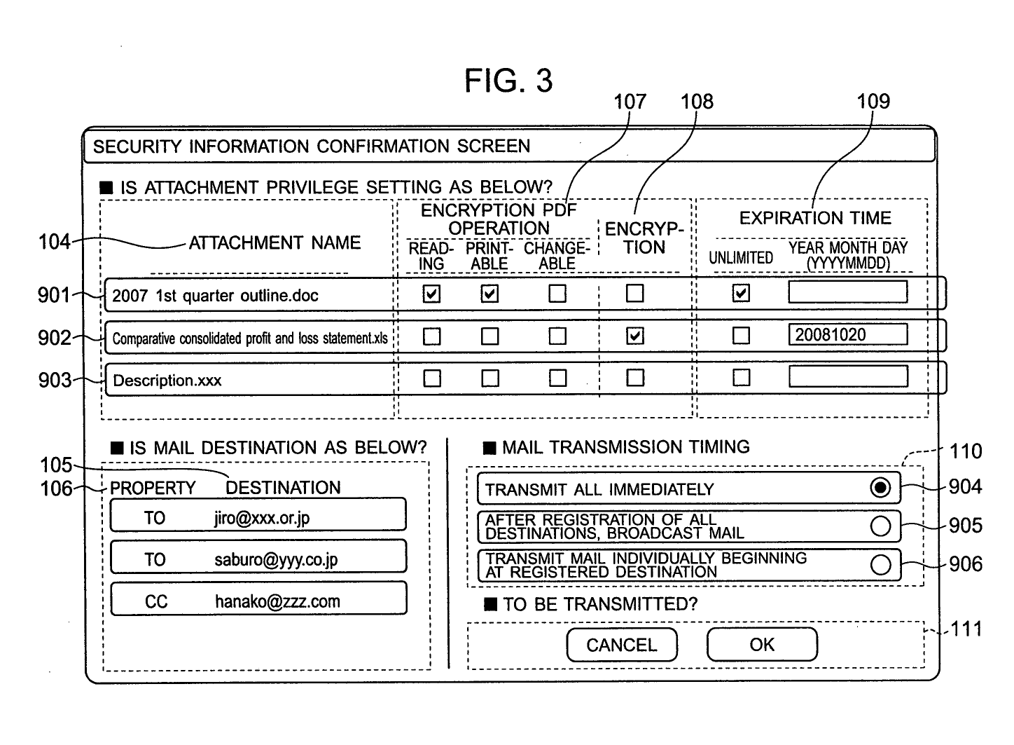

If presence of such attachment is determined, the application server 20 displays a security information confirming screen image on the screen 11 of the transmitter terminal 10 (step 1011). FIG. 3 shows an example of the screen image on the screen 11. In this case, the security information includes five items, i.e., “who allows” “whom” “to conduct what”, “for what”, “until when”. Specifically, for the attachment of mail A, “who allows”=mail A sender, “whom” destination (mail A receiver), “to conduct what”=operation for attachment (referring, printing, modifying, etc.), “for what”=attachment, and “by when”=attachment referring time limit. In FIG. 3, “who allows”=mail sender (operator of terminal 10), “whom”=destination 105, “to conduct what”=read/printable/changeable (encryption, PDF operation 107, “for what”=attachment name 104, and “by when”=expiration time 109.

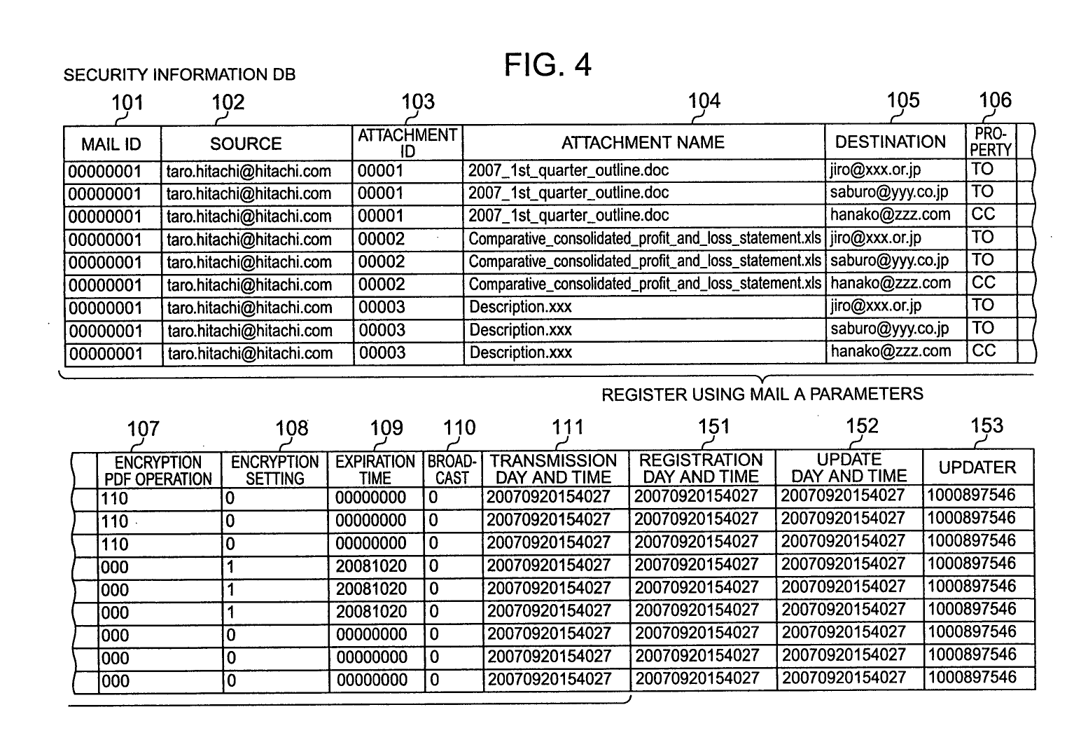

In the embodiment shown in FIG. 1, the security information database includes, in addition to the five items above, information as a criterion to determine encryption for the attachment (e.g., items 107 and 108 of FIG. 3), selection of timing of mail transmission (mail transmission timing 110 of FIG. 3), and information included in the mail header (e.g., mail transmission day and time) as shown in FIG. 4. Also, the security information database of FIG. 4 includes data items generally used for data management such as the day and time of data registration to the table (registration day and time 151) and record update information items (update day and time 152, updater 153).

For items such as the attachment referring privilege which are to be set by the mail sender, there are disposed input fields such as check boxes on the screen as shown in FIG. 3. Hence, the sender can not only confirm the security information, but also can conduct an input operation at the same time. Additionally, for other items such as the destination, it is also possible to arrange input fields for the sender to conduct operation, for example, to modify input items.

The mail transmitter terminal 10 receives an indication (input) on the security information confirmation screen from the sender to determine a next operation. For example, if the sender pushes “cancel” button for transmission confirmation 111 in FIG. 3, the transmitter terminal 10 terminates the processing. On the other hand, if the sender pushes “OK” button, the terminal 10 recognizes the operation and then transmits mail A and a set of mail A parameters including display/input information items on the security information confirmation screen of FIG. 3 via the communication line 30 to the application server 20 (step 1012).

The application server 20 receives the mail A parameters and checks presence or absence of each required item in the parameters (step 1013). The check for each indispensable item is achieved by confirming presence or absence of all data items required for the processing in the system. The check items include, for example, the expiration time 109 and the mail transmission timing 110 in FIG. 3. The check is carried out, for example, as below. The server 20 sequentially makes a check to determine presence or absence of the respective items. If an item is absent, the server 20 interrupts the check and determines absence of the item. In this regard, the server 20 includes a table of the indispensable items. By comparing these items with the received parameters, the server 20 conducts the check.

If the application server 20 detects absence of required data for at least one item of the mail A parameters, the server 20 goes to step 1011.

If the server 20 determines that all data items are present for the parameters, the server 20 checks data formats for all items of the parameters (step 1014). The check is conducted by collating each item with rules beforehand stored, for example, whether or not the expiration time 109 includes other than the numeric characters. The rules for the data format check may be beforehand set to the security information database of FIG. 3 on the basis of, for example the data type and the number of digits of the respective items.

If it is determined that the data format is not suitable for an item of the parameters, the application server 20 goes to step 1011.

If it is determined that the items of the parameters satisfy the rules to check the data formats, the application server 20 makes a check to determine presence or absence of an attachment in mail A for the encryption and PDF operation or for the encryption (step 1015). This is determined on the basis of presence or absence of the values of the check boxes for the encryption PDF operation 108 and the encryption 108 of FIG. 3, the values being contained in the mail A parameters sent from the terminal 10 in step 1012. For example, if these check boxes are empty, the server 20 determines that neither the encryption PDF operation 108 nor the encryption 108 is to be carried out.

If it is determined that neither the encryption PDF operation 108 nor the encryption 108 is required for the attachment of mail A, the application server 20 transmits mail A via the communication line 30 to the mail server 21. The mail server 30 then executes transmission processing for mail A (step 1016) and then terminates the processing.

If it is determined that neither the encryption PDF operation 108 nor the encryption 108 is to be conducted for the mail A attachment, the application server 20 creates a mail ID 101 for mail A to assign the ID 101 thereto and keeps (stores) the mail ID 101 and the mail A parameters with a correspondence established therebetween (step 1021). The mail ID 101 is data to be later stored in the data item “mail ID 101” of the security information database of FIG. 4. Since the mail ID 101 is used to discriminate mail A from the other e-mails, it is represented by a unique character string, for example, “random alphanumeric characters+time stamp (year, month, day, hour, minute, second) of a server when ID is assigned”.

The mail ID is associated with the mail itself by use of, for example, “multi-part”. When mail A transfers another e-mail, it is possible to use the mail ID of the another e-mail. In this situation, the mail ID of the another e-mail may be used without or with modification thereof. For such use, the set of mail parameters may also include the original mail ID before the transfer.

The application server 20 creates an attachment ID 103 for the mail A attachment to assign the ID to the attachment and keeps the ID 103 and the mail A parameters in the server 20 with a correspondence established therebetween (step 1022). The attachment ID 103 is data to be later stored in the data item, i.e., “attachment ID 103” of the security information database of FIG. 4. Since the attachment ID 103 is used to discriminate the attachment from the other attachments, it is represented by a unique character string, for example, “random alphanumeric characters+time stamp (year, month, day, hour, minute, second) of a server when ID is assigned”. If mail A is associated with a plurality of attachments, the serve 20 assigns an attachment ID 103 to each thereof and keeps the ID 103 and the mail A parameters in the server 20. If the mailer 13 conforms to specifications of MIME, the application server 20 can determine attachments of mail A and the number thereof by use of “multi-part” on the system side. The created attachment ID may be kept in (or may be made to belong to) the attachment or mail A.

For mail A of which the mail A parameters are kept by the application server 20, the server 20 determines the number of the attachment IDs 103 to thereby obtain the number of attachments of mail A (step 1023). The server 20 repeatedly executes the encryption processing and the security information database registering processing as many times as the number of the attachments (steps 1024 to 1029).

The application server 20 arbitrarily selects one of the attachments associated with mail A to refer to the value of the encryption PDF operation 107, contained in the mail A parameters kept in the server 20, of the selected attachment as the processing object, and determines whether or not the encryption PDF operation are required for the attachment (step 1024). For example, in FIG. 3, “reading” and “printable” are checked for the attachment 901 and the check box “changeable” is empty. Assuming that a check in the check box is “1” and no check therein is “0”, the encryption PDF operation 107 is represented as “110”. In this situation, since the value of the encryption PDF operation 107 is other than “000 (no check in all check boxes)”, the server 20 determines that the encryption PDF operation are conducted for the attachment 901 of FIG. 3.

In the above processing, steps 1012 and 1015 are conducted on the basis of the contents of the input (indication) from the mail transmitter terminal 10. However, the determination in these steps may be carried out on the basis of, for example, presence or absence of an attachment, the volume thereof, the number of attachments, the subject of mail, the sender (address), and/or the receiver (address). For example, it is possible that by disposing a function similar to the filtering function of the mailer in the application server 20, if the function satisfies at least one of “presence of an attachment”, “the capacity thereof is equal to or more than a beforehand stored value”, “the mail subject includes predetermined characters”, “a predetermined domain”, and “a predetermined address”, the server determines the encryption, the PDF operation, or the registration to the security information screen is required. In this connection, the embodiment also includes a configuration in which one of the steps 1012 and 1015 is carried out as above and the other one thereof is conducted on the basis of inputs (in the check boxes) from the mail transmitter terminal 10. It is also possible that the encryption and the security information screen registration are conducted on the basis of the respective e-mails.

If it is determined that the encryption PDF operation are required for the attachment, the application server 20 carries out the encryption and the PDF operation (step 1025). For example, in the processing associated with the encryption PDF operation 107 of the attachment of FIG. 3 in step 1024, since the value of the encryption PDF operation 107 is “110” (readable, printable), the server 20 conducts the PDF operation for the attachment with the attachment set to the readable and printable states and encrypts the attachment. At the same time, the server 20 fills the encrypted attachment with a Uniform Resource Locator (URL) of the web server 24 which conducts file access control.

If it is determined that the encryption PDF operation are not required for the attachment, the application server 20 accesses the mail A parameters kept by the server 20 to refers to the value of the encryption 108 associated with a particular attachment as a processing object and resultantly determines whether or not the attachment is required to be encrypted (step 1026). For example, for the attachment 902 of FIG. 3, the check box of the encryption 108 is examined. For the value of the encryption 108, assume that presence of a check in the box is represented as “1” and absence thereof is represented as “0”. In this situation, since the value of the encryption 108 is “0” (no check in the check box), the server 20 determines that the attachment 902 is to be encrypted.

If it is determined to encrypt the attachment, the application server 20 encrypts the file (step 1027). The encryption may be accomplished by use of, for example, the public key cryptosystem or the secret key cryptosystem. In addition to the known encryption methods, there may be employed an access control scheme in which a URL of the web server 24 disposed to conduct file access control is filled in the encrypted file such that the web server 24 conducts the access control when an attempt is made to access the attachment.

If it is not determined to encrypt the attachment, the application server 20 goes to step 1029 without executing the processing for the attachment.

If the encryption and PDF operation have been conducted (step 1025) or the encryption has been conducted (step 1027), the server 20 accesses the mail A parameters to extract therefrom the mail ID 101, the source 102, the attachment ID of the attachment 103, the attachment name of the attachment 104, the destination 105, the property 106, the encryption PDF operation 107, the encryption 108, the expiration time 109, the mail transmission timing 110, and the transmission day and time 111. The server 20 sends the extracted items via the communication line 30 to the security information registration database of the database server 22. The server 22 receives and registers the items to the database (step 1028). FIG. 4 shows an example of the security information registration database. Although not shown, it is also possible for each record to store a decryption key (or information to identify the decryption key) to decrypt the attachment and link information to connect to the decryption key. These items are used in “(F) attachment decryption function”, which will be described later. That is, the system controls operation such that these items are used by the authenticated mail receiver terminal.

The application server 20 makes a check to determine based on the number of mail A attachments obtained in step 1023 whether or not any other attachment exists for mail A. If there exists such attachment, the server 20 goes to step 1024 (step 1029). The attachments which are not treated, by the server 20, as objects of the encryption PDF operation or the encryption in steps 1024 and 1026 are regarded as processed attachment. The server 20 sets, for example, a processing completion flag, not shown, for these attachments in the security information database 22. It is also possible to write information indicating “processing completed, and not required” in the encryption PDF operation setting field and/or the encryption setting field.

If it is not determined that there exists another attachment requiring the encryption PDF operation or the encryption, the application server 20 confirms whether or not mail A is to be immediately transmitted (step 1030). “To be immediately transmitted” indicates that mail A is saved in the wait areas 25 and 26 or is transmitted with the mail receiver terminal 40 set as its destination. That is, there may exists a time lag for the transmission of mail A. Whether or not mail A is to be immediately transmitted is determined by use of, for example, the check values of radio buttons for the mail transmission timing 110 shown in FIG. 3. In this case, “transmit all immediately” 904 is checked, but “after registration of all destinations, broadcast mail” 905 and “transmit mail individually beginning at registered destination” 906 are not checked. Assume that the value of the mail transmission timing 110 is kept in the mail A parameters such that that the check for the item 904 is “1”, the check for the item 905 is “2”, and the check for the item 906 is “3”. If the value of the mail transmission timing 110 is “1”, the server 20 determines the immediate transmission and goes to step 1031. If the value is other than “1”, the server 20 goes to step 2001. “Broadcast” does not indicate to transmit the mail completely at the same time, but indicates that the mail is broadcast even if the authentication is not completed on the mail receiver terminal 42, which will be described later.

The application server 20 attaches the mail A attachment for which the encryption PDF operation (step 1025) or the encryption (step 1027) has been conducted and the mail A attachment for which the encryption has not been conducted to mail A and then deletes the original attachments of mail A (step 1031).

The application server 20 transmits mail A via the communication line 30 to the mail server 21. The server 21 then executes transmission processing of mail A (step 1032) to terminate the processing. Also, the application server 20 may conduct the determination in step 1030 according to mail A and the attachments. The server 20 may conduct the determination, for example, according to the volume of the attachments, the number of attachments, the subject of mail, the sender (address), and the receiver (address). For example, it is possible that by disposing a function similar to the filtering function of the mailer in the application server 20, if the function satisfies at least one of “the capacity of the attachments is equal to or more than a predetermined value”, “the mail subject includes predetermined characters”, and “a predetermined domain or address”, the server 20 may determine “yes” for “transmit without modification” or “no” therefor. The server 20 may skip step 1030 to the processing after “yes” or “no” for each e-mail.

By conducting “(B) file encryption function”, the system carries out the encryption of the attachment and the mail transmission control (e.g., discrimination of e-mails for which the access control is to be conducted (e-mails not to be immediately transmitted) from the other e-mails).

Referring next to FIG. 1B, description will be given of processing of “(C) user registration information query function”. This function is disposed to conduct transmission control for an e-mail for which “no” is determined for “transmit immediately” in step 1030 of “(B) file encryption function”. That is, this function is used to prepare the mail for transmission to the mail receiver terminal 40 (to determine whether or not the mail can be transmitted).

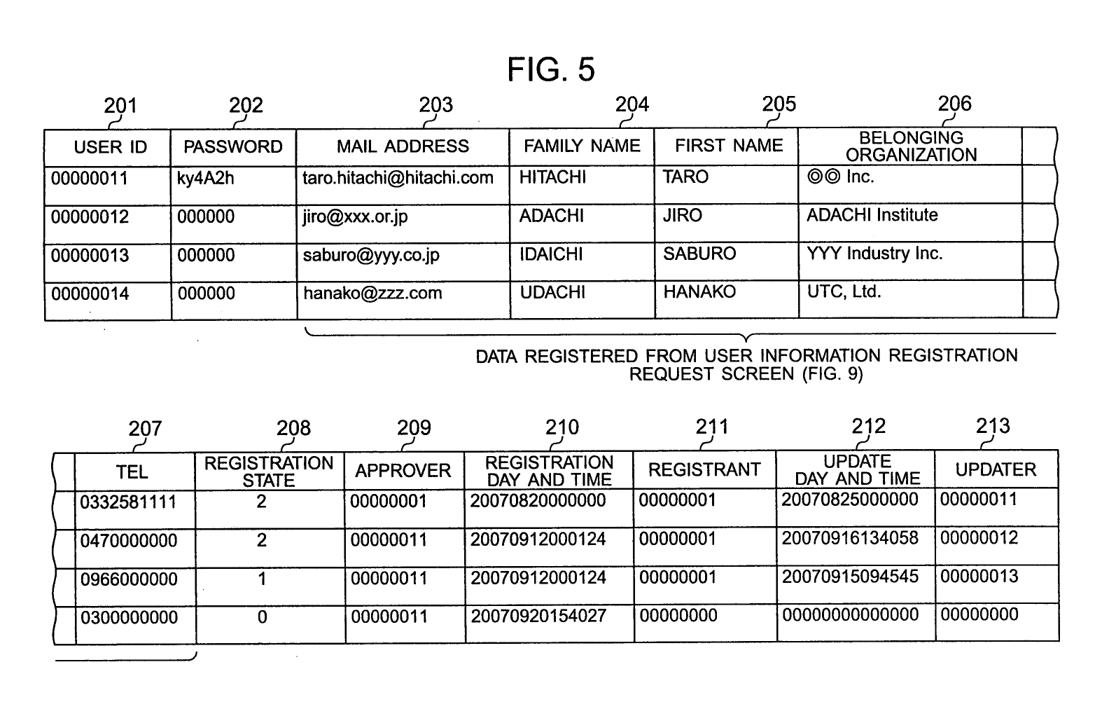

If it is not determined in step 1030 that mail A is immediately transmitted, the application server 20 issues a query via the communication line 30 to the user information registration database of the database server 23 for information whether or not the destination 105 has been registered as a user and then acquires information of unregistered users (step 2001). Specifically, by determining whether or not the destination 105 matches with the mail address 203 of the user information registration database of FIG. 5, the server 20 confirms whether or not the destination 105 has been registered as a user. As a result of the query, the server 20 receives, from the destination 105 of the mail A parameters, a list of unregistered destinations which have not been registered to the user information registration database of the database server 23. If there exist a plurality of destinations 105, the query is made for each destination to determine whether the destination matches with the mail address 203.

On the basis of the query result obtained in step 2001, the serve 20 determines whether or not the user information registration database includes at least one unregistered user (step 2002). This is conducted, for example, by determining the number of unregistered users obtained as a result of the query in step 2001.

If it is determined that there exists no unregistered user, the application server 20 goes to step 2007.

If it is determined that there exist at least one unregistered user, the server 20 goes to step 2003.

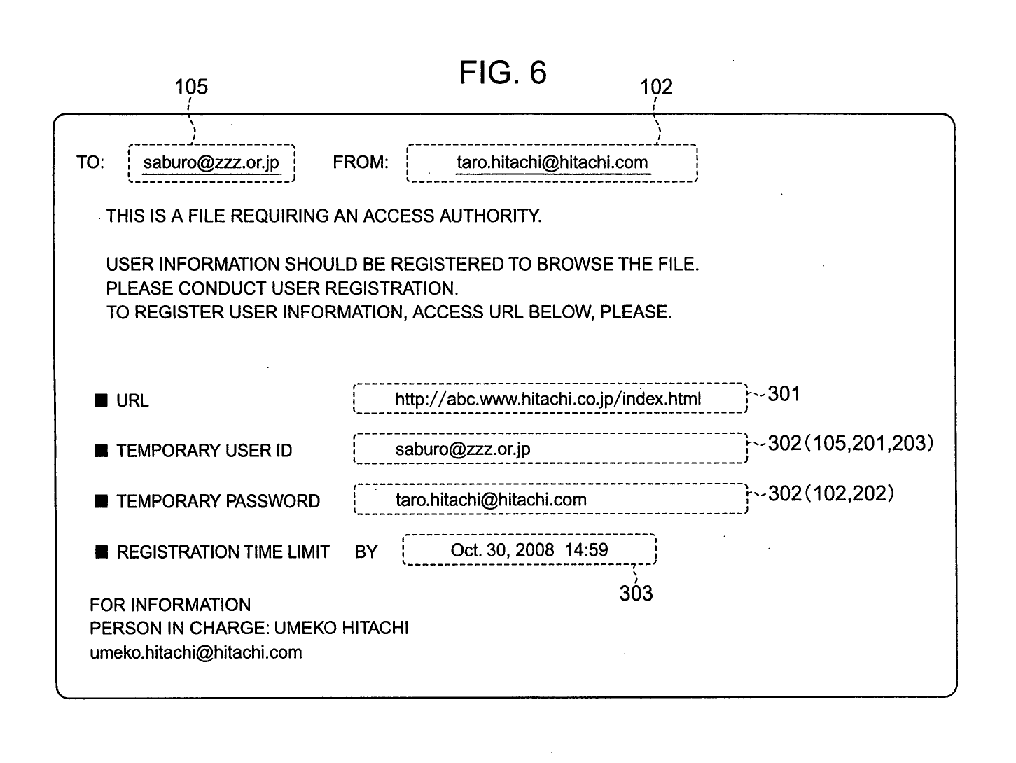

On the basis of the query result obtained in step 2001, the server 20 creates a registration request e-mail (to be referred to as mail B hereinbelow) for registration to the user information registration database like a registration request e-mail of FIG. 6 addressed to an unregistered user's destination (step 2003). In FIG. 6, by use of a mail text template file beforehand disposed in the application server 20, the mail statement is created by filling the destination and other items in the mail text template file.

The application server 20 transmits mail B via the line 30 to the mail server 21, which then executes transmission processing for mail B (step 2004).

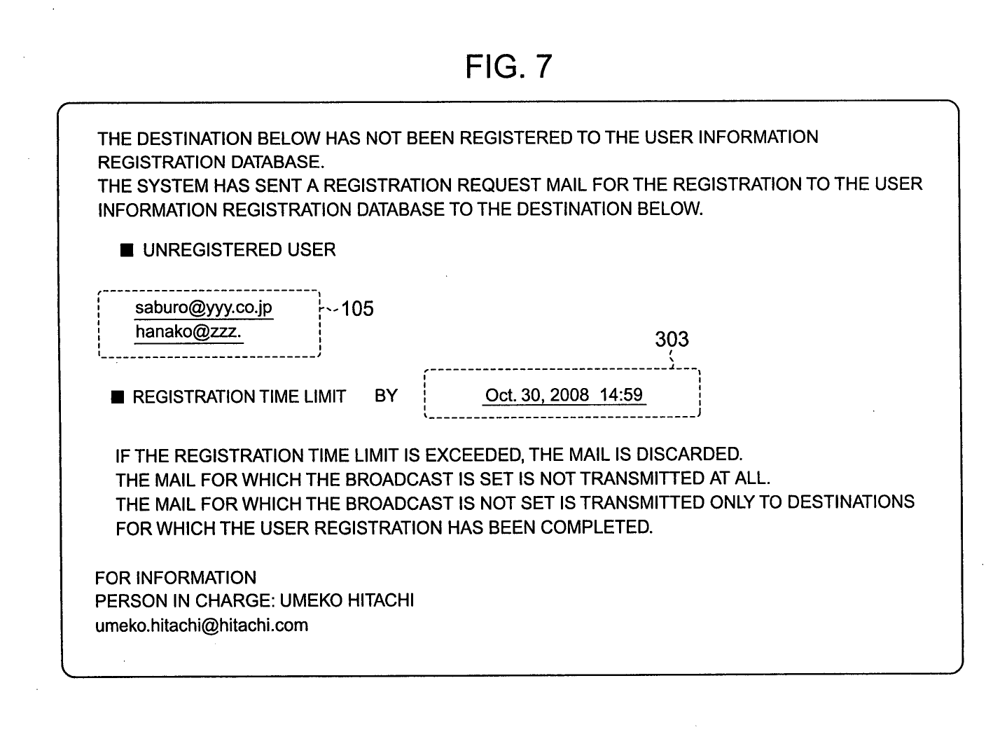

On the basis of the unregistered users' destinations obtained as a result of the query in step 2001, the server 20 creates notification mail (to be referred to as mail C hereinbelow) of unregistered users as shown in FIG. 7 for the mail A transmitter (step 2005). In FIG. 7, by use of a mail text template file beforehand disposed in the application server 20, the mail statement is created by filling the destination and other items in the mail text template file.

The application server 20 transmits mail C via the communication line 30 to the mail server 21, which then executes transmission processing for mail C (step 2006).

The server 20 refers to the mail transmission timing 110 of the mail A parameters to determine whether or not mail A is broadcast to the mail A destination after all destinations of mail A are registered to the user information registration database (step 2007). The determination is conducted using the check values of the radio buttons of the mail transmission timing 110 shown in FIG. 3. Assume that the value of the mail transmission timing 110 is kept in the mail A parameters by regarding a check for “after registration of all destinations, broadcast mail” 905 as “2” and a check for “transmit mail individually beginning at registered destination” 906 as “3”. Then, if the value of the mail transmission timing 110 is “2”, the server 20 determines the broadcast of the mail and goes to step 2008. If the value of the mail transmission timing 110 is “3”, the server 20 goes to step 2010.

In this connection, “broadcast mail A” indicates that mail A is broadcast to the mail A destination after the mail addresses of the destinations 105 of mail A are completely registered to the mail address 25 of the user information registration database. That is, in a situation wherein mail A is not broadcast, the serve 20 sequentially transmits mail A to the mail A destination for which it is determined that the mail address of the mail A destination 105 has been registered to the mail address 25 in the user information registration database. In this case, there may exist the difference in time between points of transmission of mail A as described above.

If it is determined to broadcast mail A, the application serve 20 executes processing for mail A in almost the same way as for step 1031 (step 2008).

The server 20 saves mail A processed in step 2008 in the wait area 25 (step 2009).

If it is not determined that mail A is to be broadcast, the server 20 refers to the destination 105 and the property 106 of the mail A parameters to create a copy of mail A for each destination (the copied mail of mail A will be referred to as mail AA hereinbelow; step 2010).

The application server 20 executes processing for mail AA in almost the same way as for step 1031 (step 2011).

The server 20 saves mail AA processed in step 2010 in the wait area 26 (step 2012).

The server 20 makes a check to determine whether or not mail AA kept in the wait areas 25 and 26 is within the valid time limit (step 2013). In this connection, the application server 20 beforehand stores, for example, a period of time to keep the attachment in the areas 25 and 26, the period of time being stored as a rule in the form of a parameter file. In operation, the serve 20 obtains the time when the mail transmitter terminal 10 sends mail A in step 1001 from the mail header of mail A and then adds the period of time in the parameter file to the value of the time obtained from the mail header. The server 20 compares the resultant value with the current time, i.e., the current day and time of the server 20. If the current time is older, the server 20 determines that mail A is within the time limit. The interval of time for the server 20 to conduct the confirmation of the valid time limit for the mail kept in the wait areas 25 and 26 is beforehand set to, for example, three minutes. According to the set interval of time and the set contents, the serve 20 periodically conducts step 2013.

If it is determined that the mail kept in the wait areas 25 and 26 is within the valid time limit, the server 20 determines whether or not the destination of the mail has been registered to the user information registration database (step 2014). Specifically, as in step 1030, the server 20 issues a query via the communication line 30 to the user information registration database of the database server 23 to confirm whether or not the mail address of the destination has been registered as a user on the basis of whether or not the destination mail address matches the mail address 203 of the database shown in FIG. 5. If there exist a plurality of destination mail addresses, the server 20 confirms that each of the addresses matches the associated mail address 203 of the database of FIG. 5.

If it is confirmed for mail A or mail AA that the mail address matches the mail address 203 in the user information registration database, the server 20 sends mail A or mail AA via the communication line 30 to the mail server 21, which then executes transmission processing for mail A or mail AA (step 2015) to terminate the processing.

If it is not confirmed for mail A or mail AA that the mail address matches the mail address 203, the server 20 goes to step 2013.

As a result of “(C) user information registration query function”, the mails are kept in the wait areas to wait for a request from the receiver side.

Referring next also to FIG. 1B, description will be given of processing in “(D) error processing function”. This function executes processing for an e-mail in the wait area for which the valid time limit is exceeded. Although step 2013 determines whether or not the mail is within the valid time limit, the system may conduct a control operation such that the server 20 skips step 2013 to proceed to step 2014 or 3011.

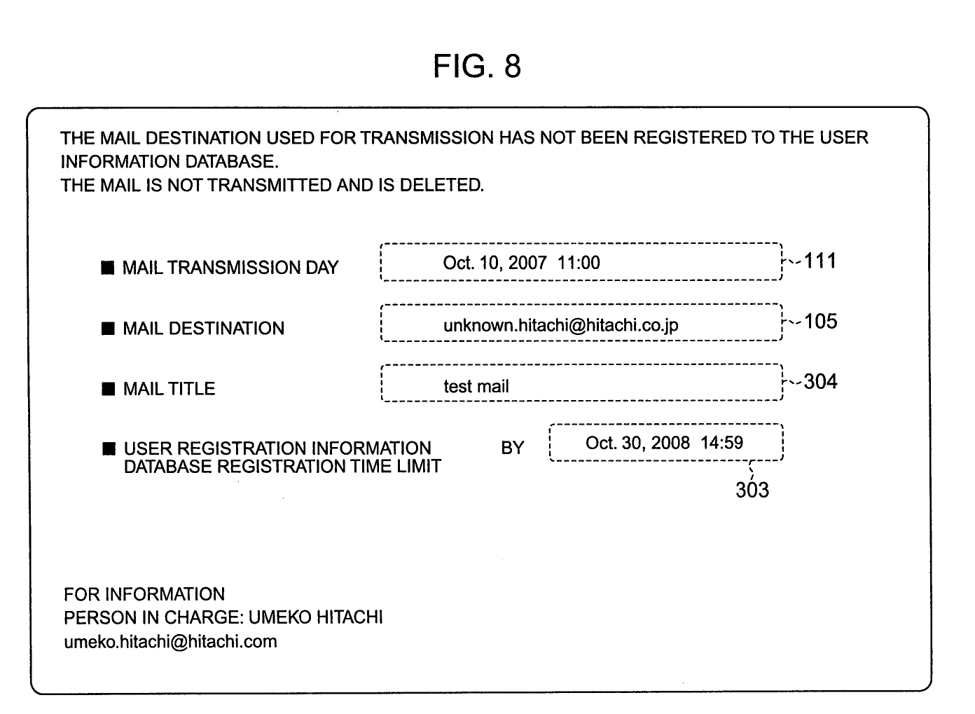

If it is not determined that either one of the e-mails kept in the wait areas 25 and 26 is within the valid time limit in step 2013, the server 20 creates, for the sender of the e-mail or mail, valid time limit overdue notification mail (to be referred to as mail E hereinbelow; step 3011) as shown in FIG. 8. In FIG. 8, by use of a mail text template file beforehand disposed in the application server 20, the mail statement is created by filling the destination and other items in the mail text template file.

The application server 20 transmits mail E via the communication line 30 to the mail server 21, which then executes transmission processing for mail E (step 3012).

The server 20 issues a query via the line 30 to the security information database of the database server 22 for a record associated with the mail determined to be beyond the valid limit time; and the record extracted as the query result is deleted from the database (step 3013). The query from the server 20 to the database is conducted by confirming whether the items of a combination including “source mail address, destination mail address, property, and transmission day and time” obtained from the mail header of the mail determined to be beyond the valid time limit match “source 102, destination 105, property 106, and transmission day and time 111”, respectively.

The server 20 deletes the mail in the wait area 25 or 26 determined to be beyond the valid period from the wait area (step 3014) and then terminates the processing.

Referring now to FIG. 1C, description will be given of processing in “(E) user information registration function”. This function includes processing to be executed in step 2004 of “(C) user information registration query function” to notify mail to the mail receiver terminal 40 and to receive a reception request therefrom.

After the mail server 21 transmits mail B in step 2004, the mail receiver terminal 40 receives mail B according to an operation of the mail B receiver. The receiver terminal 40 activates the web browser in response to an operation of the mail B receiver and accesses the URL 301 (FIG. 6) described in mail B. The web server 24 at the URL 301 displays a user information registration request login screen on the screen 41 of the receiver terminal 40 (step 4001).

The receiver terminal 40 receives a temporary user ID 302 and a temporary password 303 inputted by the mail B receiver from the keyboard 42 and then sends the temporary user ID 302 and the temporary password 303 via the communication line 31 to the web server 24 in response to a login processing start operation such as depression of a login button by the mail B receiver. The server 24 receives and then transmits the temporary user ID 302 and the temporary password 303 via the communication line 31 to the application server 20. The server 20 receives the items 302 and 303 and then issues a query via the communication line 30 to the user information registration database of the database server 23 to determine presence or absence of the user ID 302 and the password 303 for the registration. Specifically, the database server 23 makes a query to determine whether or not the user ID 201 or the mail address 203 of the user information registration database includes data matching the temporary user ID 302. If such data is present, a check is made to determine whether or not the data includes data for which the password 202 matches the temporary password 303. Having received a result of the query, the database server 23 transmits the query result via the line 30 to the application server 20 (step 4002).

If there exists no combination of the user ID 302 and the password 303 for the registration, the server 20 transmits a message indicating that the user ID or the password is wrong via the lines 30 and 31 and the web server 24 to the receiver terminal 40. On receiving the message, the terminal 40 displays an associated screen image on the screen 41 (step 4003) and terminates the processing.

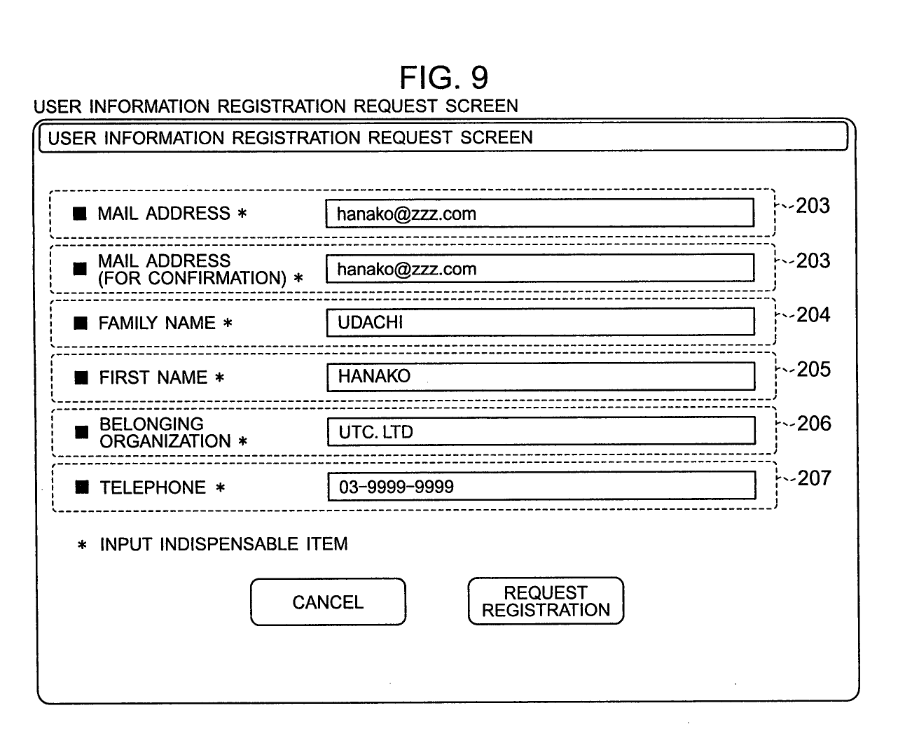

If there exists a combination of the user ID 302 and the password 303 for the registration, the server 20 displays, via the communication lines 30 and 31 and the web server 24, a user information registration request screen as shown in FIG. 9 on the screen 41 of the receiver terminal 40 (step 4004).

The terminal 40 receives an input operation of the mail B receiver from the keyboard 42 for the user information registration request screen displayed on the screen 41. When the mail B receiver completes the input operation and conducts an operation, for example, to depresses a button for the registration of the mail B receiver, the receiver terminal 40 receives the operation and then transmits, via the line 31, the web server 24, and the lines 31 and 30, the input items of the user information registration request screen as a set of registration request item parameters to the application server 20 (step 4005).

The server 20 receives the registration request item parameters from the receiver terminal 40 and conducts the indispensable item check as in step 1013 (step 4006). For example, in FIG. 9, all input items are indispensable. In the check, presence or absence of each item is sequentially determined. If an item is absent, the processing may be interrupted or it may be regarded that there exists no subsequent processing.

If at least one indispensable value is absent for the indispensable items, the server 20 goes to step 4044.

If the values are present for the indispensable items, the server 20 makes a data format check for each item of the registration request item parameters as in step 1014 (step 4007).

If it is determined that the value of any item of the parameters does not satisfy the rule to check the data format, the application server 20 goes to step 4004.

If it is determined that the values of all items of the parameters satisfy the rule, the server 20 creates an SQL statement to register data of the registration request item parameters to the user information registration database of the database server 23 and transmits the statement via the line 30 to the database server 23. The server 23 receives the SQL statement from the application server 20 and registers the data to the user information registration database. After the registration, the server 23 returns a message of completion of the registration to the application server 20 (step 4008). Assume in the temporary registration state determining method that the state of the user registration of the mail B receiver is a temporary registration state in the user information registration database. For example, an identifiable value is set to the registration state 208 of the database shown in FIG. 5. Specifically, assume that the value of the registration state 208 is defined as “0”=unregistered, “1”=temporarily registered (waiting for approval), “2”=approved, and “3”=invalid. Then, in step 4008, the value is “1” indicating “temporarily registered (waiting for approval)”, and the value is “0” indicating “unregistered” in the preceding state, i.e., the state before the mail B receiver conducts the registration request operation.

When the registration completion is received from the database server 23, the application server 20 sends an indication via the lines 30 and 31 and the web server 24 to the receiver terminal 40, the indication instructing an operation to display a message, e.g., “Registration is being requested. Request result is notified by e-mail.” on the receiver terminal 40. When the message is received, the terminal 40 displays the message on the screen 41 (step 4009) and terminates the processing.

After the data of the registration request item parameters is registered to the user information registration database in step 4008, it is required to complete the user registration for the mail B receiver who is in the temporarily registered state such that the user registration is completed for the mail address of the transmission destination 105 of mail A or mail AA before step 2014 by the application server 20. The user registration of the mail B receiver to the user information registration database is completed when the mail A sender approves the user information registration items of the mail B receiver. As in step 4001, the transmitter terminal 10 activates the web browser in response to an operation of the mail A sender and accesses the URL 301 of FIG. 6. The web server 24 at the URL 301 displays the user information registration request login screen on the screen 41 of the receiver terminal 40 (step 4021).

The mail transmitter terminal 10 receives a user ID 201 and a password 202 inputted by the mail A sender from the keyboard 12. In response to a login start operation of the sender, for example, depression of the login button, the transmitter terminal 10 sends the user ID 201 and the password 202 via the line 31 to the web server 24. The server 24 receives and sends these items via the lines 31 and 30 to the application server 20. The server receives the user ID 201 and the password 202 and then issues a query via the line 30 to the user information registration database of the database server 23 to determine presence or absence of the user ID 201 and the password 202. Specifically, a check is made to determine whether or not the user ID 201 thus received matches data of the user ID 201 or the mail address 203 of the user information registration database of FIG. 5. If such data is present, the database server 23 makes a query to determine whether or not the password 201 includes data matching the password 202 inputted by the sender. If the user ID of the sender matches that of the user information registration database, the server 23 obtains the value of the registration state 208 of the data and then transmits the result of the query via the line 30 to the application server 20 (step 4022).

If the user information registration database of the server 23 does not include the combination of the user ID 201 and the password 202, the application server 20 sends a message, e.g., “User ID or password is wrong” via the lines 30 and 31 and the web serve 24 to the transmitter terminal 10. The terminal 10 displays the message on the screen 11 (step 4023) and terminates the processing.

In a situation wherein the user information registration database of the server 23 includes the combination of the user ID 201 and the password 202 and the registration state 208 obtained by the database server 23 is “2”, the application server 20 displays via the web server 24 a menu screen on the screen 11 of the transmitter terminal 10 (step 4024). The menu screen is a screen presenting a list of functions including a function to provide, e.g., a link to proceed to the user information registration request screen displayed by the receiver terminal 40 in step 4004 and a link to proceed to a registration item update screen of the login user. The menu screen also includes a link to proceed to an approval operation.

The transmitter terminal 10 receives input items of an operation conducted by the mail sender from the keyboard 12 or the like, for example, depression of a link to proceed to the approval operation of the menu screen displayed on the screen 11 by the mail A transmitter. As a result, the transmitter terminal 10 transmits a request for transition to the approval screen via the lines 30 and 31, the web server 24, and the lines 31 and 30 to the application server 20 (step 4025).

The server 20 receives the transition request and creates and transmits a query via the line 30 to the database server 23 to retrieve a record for which the user ID 201 of the mail A transmitter matches with an approver 209 of the user information registration database and for which the registration state 208 is “1”=“waiting for approval”. When the query is received, the database server 23 conducts the query to the user information registration database to receive a result of the query therefrom and then sends the query result via the line 30 to the application server 20 (step 4026).

The server 20 receives the query result. If the user information registration database does not include such record for which the user ID 201 of the transmitter matches with an approver 209 of the user information registration database and for which the registration state 208 is “1”, the server 20 transmits a message, e.g., “no record is waiting for approval” via the lines 30 and 31, the web server 24, and the line 31 to the transmitter terminal 10. The terminal 10 receives and displays the message on the screen 11 (step 4027) and terminates the processing.

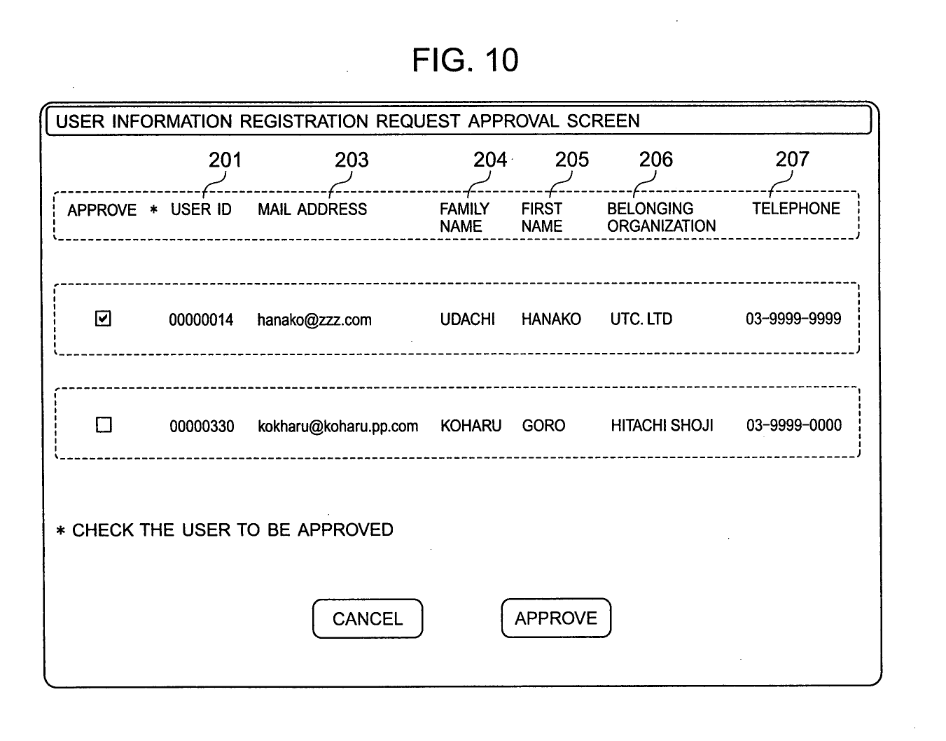

If the record matching with the condition of the above-mentioned query is present in the user information registration database, the server 20 receives as a query result the user ID 201, the mail address 203, the family name 204, the first name 205, the belonging organization 206, and the telephone number (tel) 207. The server 20 transmits the query result via the lines 30 and 31, the web server 24, and the line 31 to the transmitter terminal 10. When the query result is received, the terminal 10 displays the result in the form of an approval screen as shown on the screen 11 in FIG. 10 (step 4028).

The transmitter terminal 10 receives items inputted to the approval screen of FIG. 10 by the mail A transmitter from the keyboard 12. For example, when the transmitter completes the input operation and depresses an approval button on the screen, the transmitter terminal 10 receives the operation. As a result, the transmitter terminal 10 transmits, as approval registration item parameters, the inputted and displayed items on the approval screen via the line 31, the web server 24, and the lines 31 and 30 to the application server 20 (step 4029).

The server 20 receives the parameters and discriminates the user ID 201 contained in the parameter according to “approval” or “non-approval”. Assume that, for example, if a check box “approval” is checked, the system assumes “1” for “approval; otherwise, the system assumes “0” for “non-approval or rejection”. For the user ID to be approved, the application server 20 creates an update SQL to set the registration state 208 of the user ID to “2”=“approved” in the user information registration database. For the user ID to be rejected, the application server 20 creates an update SQL to set the registration state 208 of the user ID to “3”=“rejected” in the user information registration database and transmits the created SQL statement via the line 30 to the database server 23. The server 23 receives the statement and accordingly updates the user information registration database (step 4030).

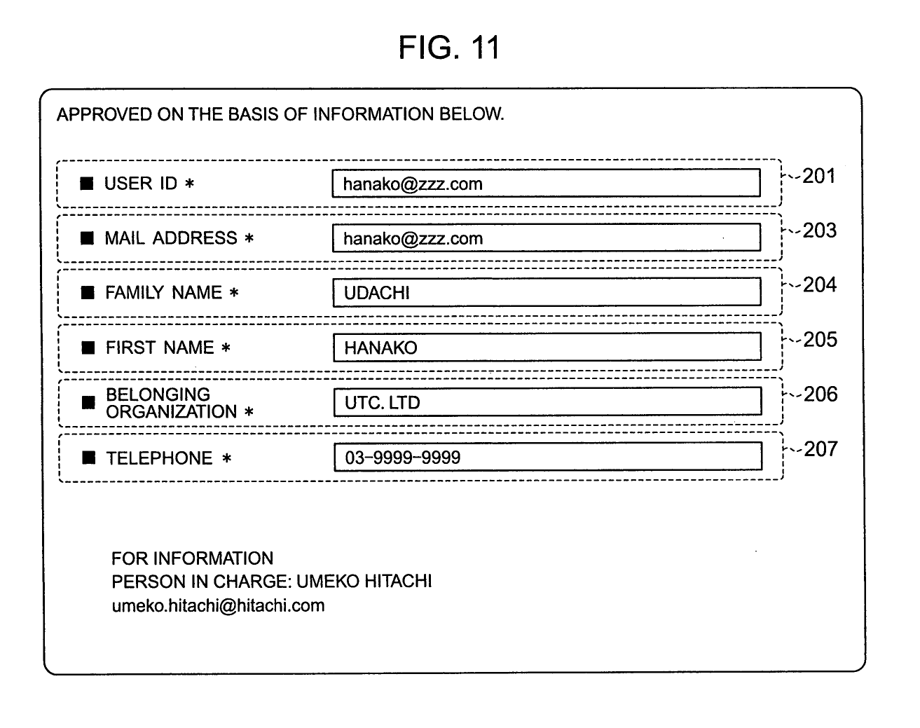

The application server 20 creates an approval notification mail (to be referred to as mail D hereinbelow) indicating an approval result as shown in FIG. 11 (step 4031). For the approval notification mail, the mail B receiver is set as the destination, i.e., the destination is extracted from the approval registration item parameters kept in the application server 20. If there exist a plurality of approved or rejected user IDs in the item parameters, the server 20 creates, for each user ID, approval result notification mail with the destination individually set thereto. In FIG. 11, by use of a mail text template file beforehand disposed in the application server 20, the mail statement is created by filling the destination and other items in the mail text template file.

The application server 20 transmits mail D via the line 30 to the mail server 21, which in turn executes transmission processing for mail D (step 4032) to terminate the processing.

Although different names mail A to mail D are used in the description, the contents thereof are substantially equal to each other. However, these e-mails may differ from each other in that, for example, a particular information item is filled therein in particular processing depending on cases.

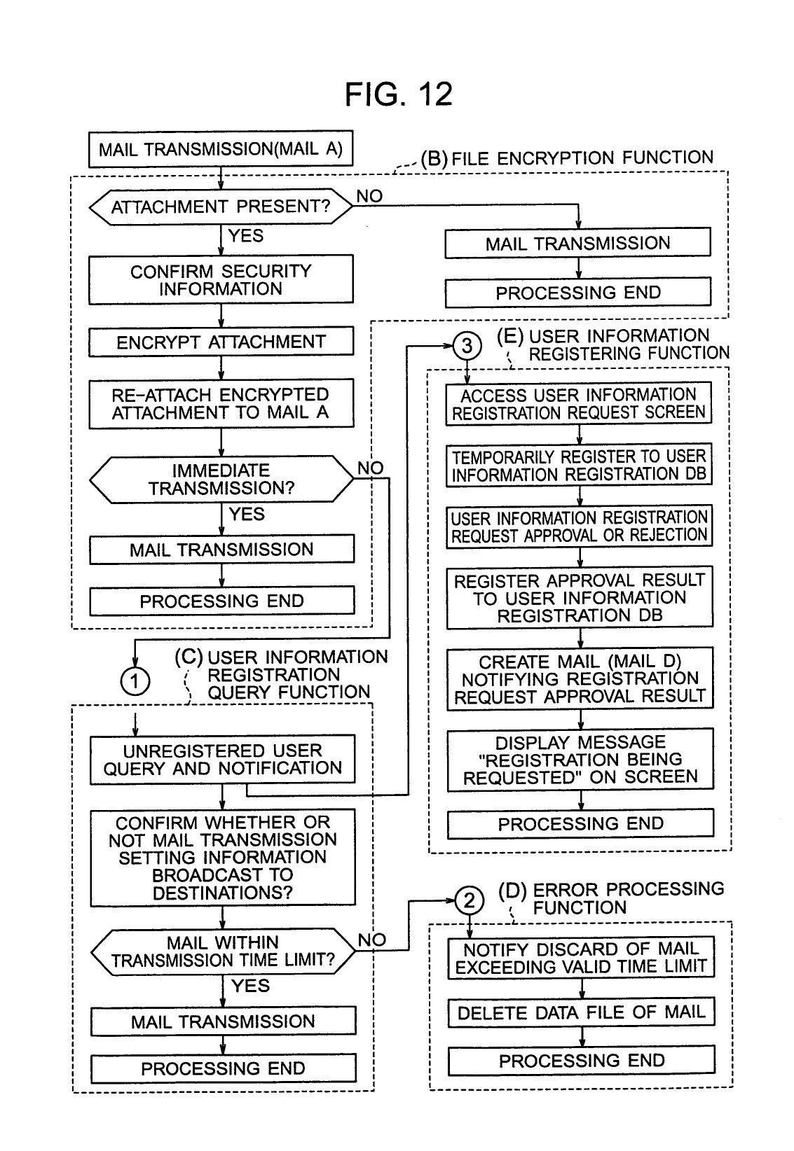

FIG. 12 shows an outline of the processing described above.

Next, by referring to FIG. 1D, description will be given of processing in “(F) attachment decryption function”, namely, processing of the receiver terminal 40 to decrypt the attachment of mail D transmitted in step 4032. As described above, the mailer or the application program executes the processing. The application program is selected to be executed depending on an extension of an associated attachment.

The receiver terminal 40 receives mail D (step 5001). Specifically, the terminal 40 receives a designation to open an attachment (step 5002).

Next, the terminal 40 reads the designated attachment of mail ID to obtain an attachment ID filled therein. The terminal 40 transmits decryption request information including the attachment ID via the web server 24 to the application server 20 (step 5003). The decryption request information may include the mail ID of mail D, or the mail ID may be used in place of the attachment ID.

The processing may be executed by the application program as below. Assume that the attachment includes header information and the header information includes an attachment ID and an instruction to send decryption request information including the attachment ID to the application server 20. The application program or the mailer controls to fill these items in the header information in the transmitter terminal 10. According to the application program, the terminal 10 reads the attachment ID from the header information of the attachment and sends the decryption request to the application server 20 by use of the instruction.

On the basis of the decryption request information, the server 20 attempts to retrieve a decryption key of the designated attachment (step 5004). That is, the server 20 makes a search through the security information database 22 for a record including the attachment ID contained in the decryption request information. If such record is retrieved, the server 20 identifies “decryption key” included in the record (information about the decryption key is not shown in FIG. 4 as described above). The server 20 accesses the security information database to retrieve therefrom a mail ID corresponding to the attachment ID in the decryption request information. The server 20 identifies an attachment ID associated with the mail ID. In a situation wherein a plurality of attachments are attached to mail D, even if one of the attachments is designated in step 5002, it is possible to identify the attachment IDs of the other attachments through this processing. For each of the attachments, the server 20 identifies a decryption key associated with an attachment ID of the attachment. In this way, the identified decryption key is related to the attachment ID. Application server 20 proceeds to step 5005 to transmit these related decryption keys to the receiver terminal 40.

If the decryption request information includes the mail ID, the server 20 retrieves an attachment ID corresponding thereto and identifies a decryption key associated with the attachment ID. If the request information includes both of the mail ID and the attachment ID, the server 20 may use either one thereof in the processing above.

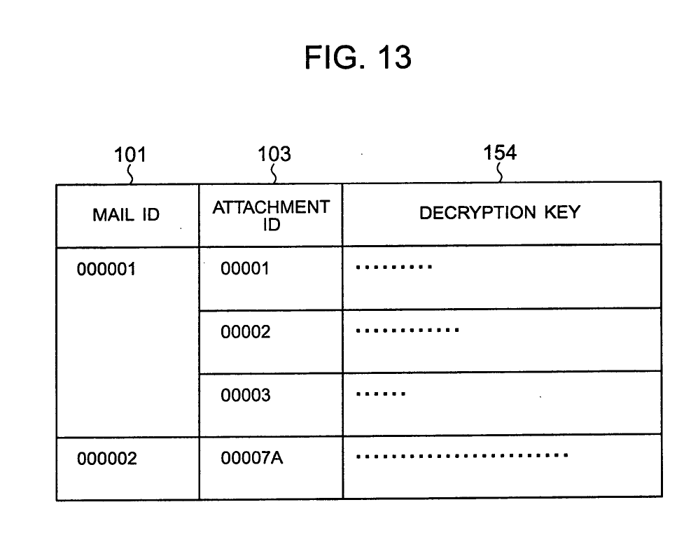

In step 5004, the server 20 may use a mail ID—attachment file ID correspondence table as shown in FIG. 13 to identify a mail ID corresponding to an attachment ID included in the decryption request information. Conversely, the server 20 may identify an attachment ID corresponding to a mail ID included in the request information. The correspondence table may be disposed in the storage of the security information database 22 or in another storage. The table is much more effective if a decryption key is set for each attachment.

In a situation in which a decryption key is set for each destination (receiver) in the security information database, the decryption request information includes a destination (mail address) to thereby identify a decryption key thereof.

It is also possible that an attachment not encrypted is determined on the basis of the encryption setting 108 of the security information database to transmit information indicating “not encrypted”. The correspondence table may include a field of “encryption setting” and may record therein attachment IDs of encrypted attachments (excepting those not encrypted).

The receiver terminal 40 receives the decryption key (corresponding to the attachment) sent in step 5005 (step 5006).

When the decryption key is received, the receiver terminal 40 extracts a decryption key corresponding to the attachment designated in step 5002 (step 5007). If a plurality of decryption keys are received, a decryption key to be extracted is identified as below. In the embodiment, the receiver terminal 40 keeps an attachment ID of the attachment designated in step 5002 and compares this ID with the attachment ID of the decryption key transmitted as above.

By use of the decryption key obtained in step 5007, the receiver terminal 40 decrypts the attachment designated in step 5002. If information indicating that the attachment is not encrypted is received, the terminal 40 directly opens the attachment. Since the terminal 40 can determine whether or not the attachment is encrypted, the terminal 40 may skip the processing of step 5003 and subsequent processing to open the designated attachment. Alternatively, it is also possible that the terminal 40 determines whether or not the attachment is encrypted such that if it is determined that the attachment is encrypted, the terminal proceeds to step 5003. In a situation in which there exist a plurality of attachments, even if it is determined that the designated attachment is not encrypted, the server 40 may proceed to step 5003 if another attachment is encrypted.

Using the decryption key extracted in step 5007, the receiver terminal 40 decrypts the attachment designated in step 5002 (step 5008-1). In this situation, the terminal 40 may store the decryption key in an appropriate storage area.

If a decryption key other than the decryption key of the designated attachment is received, the receiver terminal 40 stores these keys in an appropriate storage area with a correspondence established between the keys and the attachment IDs (step 5008-2). Each of the decryption keys stored in steps 5008-1 and 5008-2 may be deleted after the key is used for a predetermined number of times (including a case in which the key is used once). For this purpose, the system may be configured such that each time the decryption key is used (each time the decryption is conducted), a counter is activated as follows. For each information item to identify the decryption key (or, for each attached ID), a value of uses of the decryption key or a value obtained by subtracting the value of uses of the decryption key from the value of a fixed number of uses is stored in a storage area of the terminal 40.

If designation of an attachment other than that designated in step 5002 is received, the receiver terminal 40 decrypts the attachment by use of the decryption key stored in step 5008-2. The system may also control operation as below. By removing the storing processing of step 5008 and the processing of step 5004 for the attachment other than the designated attachment, the receiver terminal 40 requests the application server 20 for a decryption key of the designated attachment each time an attachment is designated.

In the embodiment, the decryption key is transmitted from the application server 20. However, it is also possible that the decryption key is filled in (or is made to belong to) the mail or the attachment in the form not to be used without particular information. When it is required to use the decryption key, the particular information is transmitted. That is, the particular information makes the decryption key available (validation, release of invalidation), for example, for the displaying and editing operations.

Also the processing of steps 5008-1 and 5008-2 may be executed by the application program according to the instruction contained in the header information. For “erase” (restriction of the number of decryption operations by use of the counter), the receiver server 40 transmits information including the event of the decryption and the rewriting indication of the security information to the application server 20 according to the application program. When the information is received, the server 20 records the number of decryption operations in a counter area, not shown, of the security information database of FIG. 5 and then compares the number with a predetermined threshold value. If the number is equal to or more than the threshold value, the server 20 may register “invalidation” by recording the day and time of reception of the expiration time 109.

In this way, it is also possible to decrypt (to browse) an encrypted attachment.

The processing of step 5003 and subsequent processing may be generally executed as follows. According to either one of the mailer, the application program, and the application server 20, the ID and the password are received via the receiver terminal 40 from the mail receiver. Based on the ID and the password, possibility of transmission of the decryption key is determined and the decryption key retrieval is carried out. Description will be given in detail of the operation.

When the designation of an attachment is received, the receiver terminal 40 displays a screen requesting an ID and a password in step 5003. The display operation may be conducted by the mailer or may be conducted by the application program according to the ID and password request information in the header information or in response to an indication from the application server 20.

The receiver terminal 40 transmits the ID and the password received from the mail receiver to the application server 20.

In step 5004, the server 20 makes a search through the user information registration database of FIG. 5 to determine whether or not the ID and the password match the ID and the password in the database. If “matching” results, the server 20 accesses the security information database to identify a decryption key corresponding to the ID. Alternatively, it is also possible to receive the attachment ID from the receiver terminal 40 to identify the decryption key by making a search through the security information database using the attachment ID as a search key. Also, the mail address may be employed as the ID.

It should be further understood by those skilled in the art that although the foregoing description has been made on embodiments of the invention, the invention is not limited thereto and various changes and modifications may be made without departing from the spirit of the invention and the scope of the appended claims.

1. A mail transmission method of transmitting, from a transmitter unit for transmitting an electronic mail, the mail by setting a receiver unit as a destination of the mail, comprising the steps of:
transmitting an electronic mail from the transmitter unit to a server unit;
storing the mail by the server unit;
receiving by the server unit, from the transmitter unit, information of a condition to deliver the mail stored by the server unit to the receiver unit;
transmitting by the server unit a registration screen to the receiver unit as a destination of the mail, the screen receiving input of information that the mail has been transmitted, information to authenticate a receiver of the mail, and/or information to desire reception of the mail;
receiving by the server unit, from the receiver unit, contents of the input from a user to the registration screen; and
comparing by the-server unit, the contents thus received with the information of the condition and transmitting the mail to the receiver unit if the contents satisfy the information of the condition.

2. A mail transmission method according to claim 1, wherein
the server unit transmits, at reception of information of a request requesting the registration screen from the receiver unit, the registration screen to the receiver unit.

3. A mail transmission method according to claim 1, wherein
the server unit stores the mail if the mail satisfies a predetermined condition; and
the server unit transmits the mail to the receiver unit if the mail does not satisfy the predetermined condition.

4. A mail transmission method according to claim 3, wherein the predetermined condition includes a change indication from the transmitter unit to the mail and an indication whether or not the information of the condition is used as a condition to transmit the mail.

5. A mail transmission method according to claim 4, wherein
the mail includes an attachment attached thereto; and
the change indication is an encryption indication for the attachment.

6. A mail transmission method of transmitting, from a transmitter unit for transmitting an electronic mail including an attachment attached thereto, the mail by setting a receiver unit as a destination of the mail, comprising the steps of:
transmitting the mail from the transmitter unit to a server unit;
creating, by the server unit, a mail identifier (ID) to identify the mail;
executing, by the server unit, invalidating processing for the attachment;
creating, by the server unit, an attachment ID to identify the attachment;
storing, by the server unit, the mail ID and the attachment ID in a security information database with a correspondence established between the attachment ID and a validating condition which is disposed to validate the mail ID, the attachment ID, and the attachment;
transmitting, from the transmitter unit to the receiver unit, the mail to which the invalidated attachment obtained by invalidating the attachment is attached;
receiving, by the receiver unit, a validating indication for the invalidated attachment;
transmitting, from the receiver unit to the server unit, a validating request including validation confirming information to confirm whether or not validation of the mail ID and the invalidated attachment is possible;
retrieving, by the server unit, an attachment ID corresponding to the mail ID from the security information database;
identifying, by the server unit, a validating condition corresponding to the attachment;
determining, by the server unit, whether or not the validation confirming information satisfies the validating condition;
transmitting, by the server unit, a validating key to validate the invalidated attachment to the receiver unit if the validation confirming information satisfies the validating condition; and
making it possible, by the receiver unit, to validate the invalidated attachment by use of the validating key.

7. A mail transmission method according to claim 6, wherein the invalidating processing includes encryption processing for the attachment.

8. A mail transmission method according to claim 6, wherein:
the mail includes a plurality of attachments attached thereto;
the server unit transmits a validating key of each of the attachments to the receiver unit; and
the receiver unit executes, if one of the attachments is designated, validating processing for the attachment designated by a validating key corresponding thereto.

9. A mail transmission method according to claim 6, wherein if the receiver unit transfers the mail by attaching the attachment thereto, the server unit assumes that an attachment ID of the attachment attached to the mail to be transferred is an attachment ID of the attachment.

10. A mail transmission method according to claim 6, wherein the server unit transmits the validating key by establishing a correspondence between the validating key and an attachment ID of an attachment to be validated by the validating key.

11. A mail server unit which is connected to a transmitter unit to transmit an electronic mail and a receiver and which relays the mail transmitted from the transmitter unit to the receiver unit set as a destination, comprising:
means for receiving an electronic mail transmitted from the transmitter unit;
means for storing the mail;
means for receiving, from the transmitter unit, information of a condition to deliver the mail stored by the server unit to the receiver unit;
means for transmitting a registration screen to the receiver unit as a destination of the mail, the screen accepting input of information that the mail has been transmitted, information to authenticate a receiver of the mail, and/or information to desire reception of the mail;
means for receiving, from the receiver unit, contents of the input from a user to the registration screen; and
means for comparing the contents thus received with the information of the condition and transmitting the mail to the receiver unit if the contents satisfy the information of the condition.

12. A mail server unit according to claim 11, wherein at reception of information of a request requesting the registration screen from the receiver unit, the server unit transmits the registration screen to the receiver unit.

13. A mail server unit according to claim 11, wherein
the server unit stores the mail if the mail satisfies a predetermined condition; and
the server unit transmits the mail to the receiver unit if the mail does not satisfy the predetermined condition.

14. A mail server unit according to claim 13, wherein the predetermined condition includes a change indication from the transmitter unit to the mail and an indication whether or not the information of the condition is used as a condition to transmit the mail.

15. A mail server unit according to claim 14, wherein
the mail includes an attachment attached thereto; and
the change indication is an encryption indication for the attachment.
